(19) United States
(12) Patent Application Publication
(10) Pub. No.: US 2019/0371190 A1
(43) Pub. Date: Dec. 5, 2019

(54) STUDENT-CENTERED LEARNING SYSTEM WITH STUDENT AND TEACHER DASHBOARDS

(71) Applicant: Microsoft Technology Licensing, LLC, Redmond, WA (US)

(72) Inventors: Shay G. Harris, Redmond, WA (US); Maria Langworthy, Medina, WA (US); Mark A. Sparvell, Kirkland, WA (US); Grant Gumina, Redmond, WA (US)

(21) Appl. No.: 16/000,713

(22) Filed: Jun. 5, 2018

(51) Int. Cl. G09B 5/02

(52) U.S. Cl. CPC G09B 5/02; G06F 3/0482

(57) ABSTRACT

Systems and methods for assisting student-centric learning. In one example, the system includes a display device and an electronic processor communicatively connected to the display device. The electronic processor is configured generate a student dashboard, and a teacher dashboard. The electronic processor also sends a request for a data set associated with a student, the data set including at least one of goals, interests, work product, and a mood indicator associated with the student. The electronic processor also receives the data set associated with the student, shares the data set with the teacher dashboard, and generates a graphical user interface including the teacher dashboard. The teacher dashboard includes data from the data set. The electronic processor controls the display device to display the graphical user interface.

### FIELD

Embodiments relate to systems to facilitate student-centered learning, and in one example, to interfaces (for example, graphical dashboards) that improve student self-reflection, agency, and ownership of learning and a teacher's ability to monitor and interact with students.

### BACKGROUND

Educators around the world have sought ways to address the weakness of the current education paradigm for decades. To this end, the education industry focused its products, services, and technologies on how to help the teacher be a more effective practitioner. However, large interventions to improve teaching at scale did not result in clear improvements in student outcomes. Teachers were resistant to being measured by external, policy-mandated standards that they often felt were artificial, and professional development programs designed to “improve” teaching generally failed.

Being a middle or high school student in the United States is more complex than ever before. Social networking application such as Snapchat, Instagram, and mass media increase the visibility and pressure to have it all together—grades, friends, extra-curricular activities, appearance, etc. Yet one-on-one conversations between students and teachers often remain transactional, focused on assignments and grades. In United States high schools, where the likelihood of disengaging and dropping out is highest, teachers are focused on getting students ready for tests that will make them “college ready.” All of this reduces the student to their capacity to master curricular content, which is important, but is only one portion of the whole person.

### SUMMARY

The following presents a simplified summary of one or more implementations of the present disclosure in order to provide a basic understanding of such implementations. This summary is not an extensive overview of all contemplated implementations, and is intended to neither identify key or critical elements of all implementations nor delineate the scope of any or all implementations. Its sole purpose is to present some concepts of one or more implementations of the present disclosure in a simplified form as a prelude to the more detailed description that is presented later.

While there is a general understanding among educators and policy makers regarding deficiencies in current educational practices and some efforts to develop programs and measures that are directed to the whole person, particularly a student's social and emotional competencies, software and computer-based tools that support these competencies are generally not available or well developed.

Embodiments provide, among other things, a software-generated virtual space that includes dashboards that facilitate or otherwise assist student-centric learning. One example provides a software application architected or otherwise configured to enable student-centered learning that addresses the goals of (i) supporting a student's development of competencies needed for lifetime success, (ii) providing schools with new tools to know and to help all aspects of student's development (not just academic achievement), (iii) developing a locus for personalized learner interfaces or dashboards that provide information on progress in the learning process to both the student and the teacher. In one example, the system is configured to provide a virtual space to cultivate each student's capacity for self-reflection, agency, and ownership of their learning. In one instance, this is achieved via several interfaces that (i) prompt personal goal-setting and self-definition; (ii) a digital portfolio system where students connect their assignments and activities with their goals and receive learning recommendations; (iii) a personal dashboard to monitor and reflect on the progress; and (iv) a conversation platform to drive student self-awareness and self-management. In some embodiments, the conversation platform is configured to periodically ask the student to how they are feeling, and then prompt the student to provide commentary (such as self-reflection) that could be added through video, image, digital ink, text, or audio.

Certain embodiments also provide interfaces and other tools for creating and developing a student's digital portfolio. The digital portfolio provides a mechanism for collecting examples of the student's work during their schooling. The digital portfolio provides a mechanism to link a student's work and assignments to his or her personal goals and also provides the student a mechanism to reflect on what they have learned.

One example embodiment includes a system for assisting student-centric learning. The system includes a display device and an electronic processor communicatively connected to the display device. The electronic processor is configured to generate a customizable, student dashboard, and a customizable, teacher dashboard. The electronic processor also sends a request for a data set associated with a student. The data set includes at least one selected from the group consisting of goals, interests, work product, and a mood indicator associated with the student. The electronic processor also receives the data set, shares the data set with the teacher dashboard, and generates a graphical user interface including the teacher dashboard. The teacher dashboard includes data from the data set. The electronic processor controls or otherwise causes the display device to display the graphical user interface.

Another example embodiment includes a method for assisting student-centric learning. The method includes generating a customizable, student dashboard, and generating a customizable, teacher dashboard. The method also includes sending a request for a data set associated with a student, the data set including at least one selected from the group consisting of goals, interests, work product, and a mood indicator associated with the student. The method also includes receiving the data set associated with the student, sharing the data set with the teacher dashboard; and generating a graphical user interface including the teacher dashboard. The teacher dashboard includes data from the data set. The method also includes displaying the graphical user interface using the display device.

Another embodiment includes a non-transitory computer-readable medium containing instructions that when executed by one or more electronic processors cause the one or more electronic processors to generate a customizable, student dashboard, and a customizable, teacher dashboard. The instructions cause the one or more electronic processors to send a request for a data set associated with a student. The data set includes at least one selected from the group of goals, interests, work product, and a mood indicator associated with the student. The instructions cause the one or more electronic processors to receive the data set associated with the student, share the data set with the teacher dashboard, and generate a graphical user interface including the teacher dashboard. The teacher dashboard includes data from the data set. The instructions cause the one or more electronic processors to display the graphical user interface on the display device.

### BRIEF DESCRIPTION OF THE DRAWINGS

The present disclosure will be better understood from the following detailed description read in light of the accompanying drawings, wherein like reference numerals are used to designate like parts in the accompanying description.

FIG. 1 is a network diagram depicting an example student-centered learning system within which various embodiments may be deployed.

FIG. 2A is a block diagram illustrating example client computing device(s) that implements various embodiments.

FIG. 2B is a block diagram illustrating an example server that implements various embodiments.

FIG. 3 is an example of a graphical user interface illustrating a student dashboard.

FIG. 4 is another example of a graphical user interface illustrating the student dashboard.

FIG. 5 is another example of a graphical user interface illustrating a teacher dashboard.

FIG. 6 is an example of a graphical user interface of the teacher dashboard illustrating a feedback window associated with a student.

FIG. 7 is an example of a graphical user interface of the teacher dashboard illustrating a completed feedback window associated with the student.

FIG. 8 is another example of a graphical user interface illustrating the student dashboard.

FIG. 9 is an example of a graphical user interface illustrating the student dashboard showing personal analytics associated with the student.

FIG. 10 is an example flow chart of a method for assisting student-centric learning, in accordance with some embodiments.

### DETAILED DESCRIPTION

One or more embodiments are described and illustrated in the following description and accompanying drawings. These embodiments are not limited to the specific details provided herein and may be modified in various ways. Furthermore, other embodiments may exist that are not described herein. Also, the functionality described herein as being performed by one component may be performed by multiple components in a distributed manner. Likewise, functionality performed by multiple components may be consolidated and performed by a single component. Similarly, a component described as performing particular functionality may also perform additional functionality not described herein. For example, a device or structure that is “configured” in a certain way is configured in at least that way, but may also be configured in ways that are not listed. Furthermore, some embodiments described herein may include one or more electronic processors configured to perform the described functionality by executing instructions stored in non-transitory, computer-readable medium. Similarly, embodiments described herein may be implemented as non-transitory, computer-readable medium storing instructions executable by one or more electronic processors to perform the described functionality. As used in the present application, “non-transitory computer-readable medium” comprises all computer-readable media but does not consist of a transitory, propagating signal. Accordingly, non-transitory computer-readable medium may include, for example, a hard disk, a CD-ROM, an optical storage device, a magnetic storage device, a ROM (Read Only Memory), a RAM (Random Access Memory), register memory, a processor cache, or any combination thereof.

In addition, the phraseology and terminology used herein is for the purpose of description and should not be regarded as limiting. For example, the use of “including,” “containing,” “comprising,” “having,” and variations thereof herein is meant to encompass the items listed thereafter and equivalents thereof as well as additional items. The terms “connected” and “coupled” are used broadly and encompass both direct and indirect connecting and coupling. Further, “connected” and “coupled” are not restricted to physical or mechanical connections or couplings and can include electrical connections or couplings, whether direct or indirect. In addition, electronic communications and notifications may be performed using wired connections, wireless connections, or a combination thereof and may be transmitted directly or through one or more intermediary devices over various types of networks, communication channels, and connections. Moreover, relational terms such as first and second, top and bottom, and the like may be used herein solely to distinguish one entity or action from another entity or action without necessarily requiring or implying any actual such relationship or order between entities or actions.

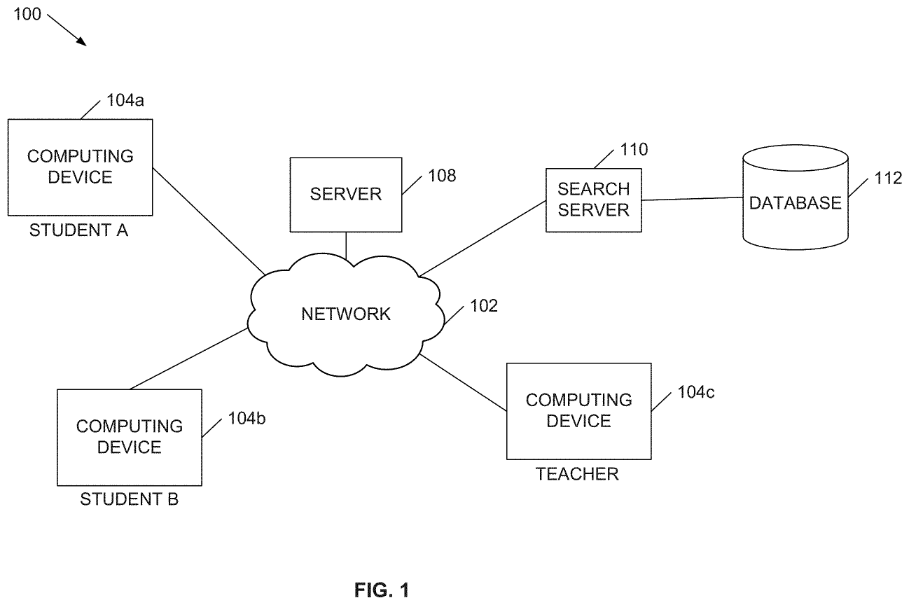

FIG. 1 is a network diagram depicting an example student-centered learning system 100 within which various embodiments may be deployed. The student-centered learning system 100 includes computing devices 104a, 104b, and 104c that access a server 108, and a search server 110 coupled to a database 112 via a network 102. The student-centered learning system 100 may operate locally or in a distributed environment, such as in client-server or cloud services architecture. Any distributed components of the student-centered learning system 100 may communicate with each other or be accessed over at least one computer network, for example, the Internet, an intranet, a local area network (LAN), or a wide area network (WAN). The computing devices 104a, 104b, and 104c (sometimes referred to as computing devices) can be implemented as any number of computing devices, including, without limitation, a personal computer, a laptop computer, a desktop computer, a portable communication device (for example, a mobile phone or a tablet), or other electronic devices. The network(s) 102 is representative of many different types of networks, and includes wired and/or wireless networks that enable communications between the various entities in the student-centered learning system 100. In some embodiments, the network(s) 102 can include the networks mentioned above, mobile telephone networks (MTNs), and other types of networks, possibly used in conjunction with one another, to facilitate communication between the server 108 and the computing devices 104a, 104b, and 104c. In some embodiments, the configurations described herein are in the context of a web-based system. However, other types of client/server-based communications and associated application logic could be used. As shown in FIG. 1, computing device 104a is associated with Student A, computing device 104b is associated with Student B, and computing device 104c is associated with a Teacher.

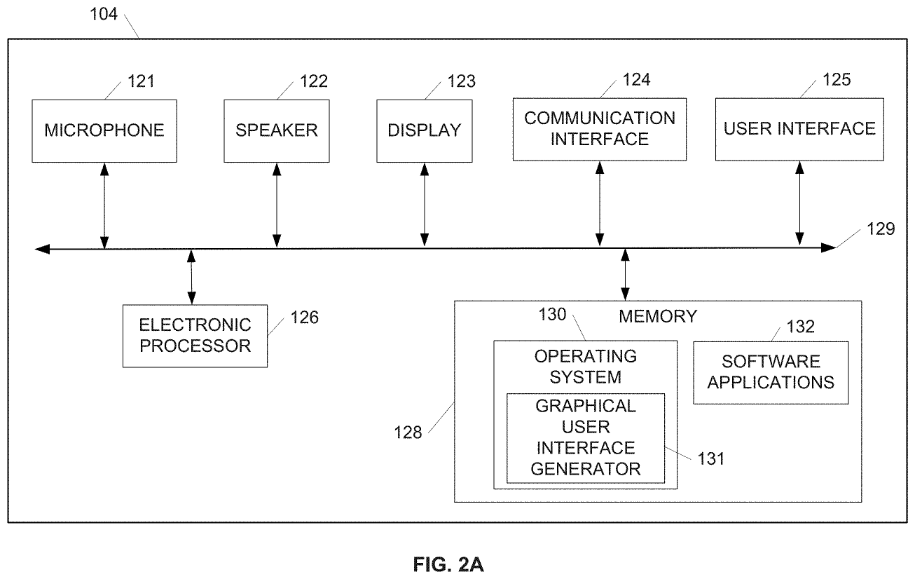

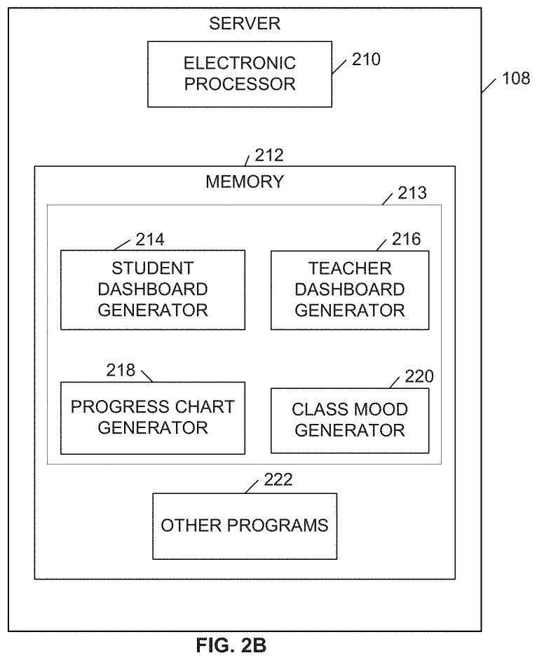

FIG. 2A is a block diagram illustrating example computing device(s) 104 shown in FIG. 1 that implement various embodiments. The computing device 104 includes a microphone 121, a speaker 122, a display device 123, a communication interface 124, a user interface 125, an electronic processor 126, and a memory 128 coupled to a data bus 129.

The communication interface 124 provides the computing device 104 a communication gateway to external networks (for example, a wireless network, the Internet, etc.). The communication interface 124 may include, for example, an Ethernet card or adapter or a wireless local area network (WLAN) card or adapter (for example, IEEE standard 802.11a/b/g/n). The communication interface 124 may include address, control, and/or data connections to enable appropriate communications on the external network.

The user interface 125 provides an input mechanism such as a keyboard that may be a physical keyboard or a “soft” keyboard generated on a touch screen display. The user interface 125 is configured to receive user input to access and interact with one or more software applications 132 (including software programs) stored in memory 128.

The electronic processor 126 may include at least one electronic processor or microprocessor that interprets and executes a set of instructions stored in the memory 128. The memory 128 includes an operating system 130 and software applications 132. In the example shown, the operating system 130 includes a graphical user interface generator 131 that creates a graphical user interface on the display device 123. The software programs 132 are configured to, among other things, implement the methods described herein. The memory 128 includes volatile memory elements (for example, random access memory (RAM)), nonvolatile memory elements (for example, read only memory (ROM)), and combinations thereof. In some embodiments, the memory 128 has a distributed architecture, where various components are situated remotely from one another, but may be accessed by the electronic processor 126.

The data bus 129, or other component interconnection, permits communication among the components of the computing device 104. The data bus 129 may have additional elements, which are omitted for simplicity, such as controllers, buffers (for example, caches), drivers, repeaters and receivers, or other similar components, to enable communications. The data bus 129 may also include address, control, data connections, or a combination of the foregoing to enable appropriate communications among the aforementioned components.

FIG. 2B is a block diagram of the server 108 shown in FIG. 1. In the example provided, the server 108 includes an electronic processor 210, and a memory 212 including one or more software applications(s). The computing device 104 accesses software application(s) in memory 212 of server 108 through the network 102. The software application(s) can include a student agency application 213. In the example shown, the student agency application 213 includes a student dashboard generator 214, a teacher dashboard generator 216, a progress chart generator 218, a class mood generator 220, and other programs 222.

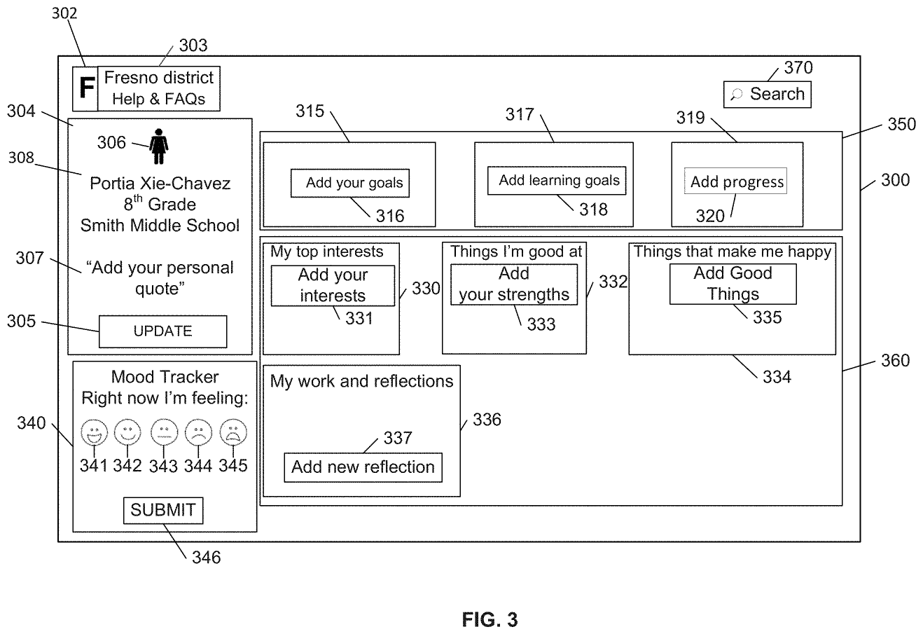

FIG. 3 is an example of a graphical user interface illustrating a student dashboard 300. It should be understood that, in one example, elements of the student agency application 213 (executed by the electronic processor 210) along with local components of the computing devices 104a-c (for example, the graphical user interface generator 131 executed by the electronic processor 126) cause the graphical user interface to be displayed on a display device (for example, the display device 123). While one example is shown, the location of hardware and software in various networked implementations does not need to conform to the particular architecture illustrated. Other ways of distributing functions, features, and logic are possible.

The student dashboard 300 provides mechanisms to prompt a student for information about and associated with the student. Information gathered via the student dashboard 300 is used to populate a database, for example, the database 112 which may contain data sets (for example, for each student). Each data set includes data. In the description that follows, some features are described in terms of what they allow a user to accomplish. However, it should be understood that the student-centered learning system 100 causes, for example, graphical user interface elements to be displayed and responds to input received via to user actions with the graphical user interface in the form of text, mouse or cursor selections, etc.

The student dashboard 300 includes a school identification pane 302 that, as its name suggests, includes a school name, logo, and/or other identifier. The student dashboard also includes a user profile pane 304, a first student activity panel 350, a second student activity panel 360, and a mood tracker 340 pane. In one example, the school identification pane 302 includes a help and FAQs button 303, which when activated causes the graphical user interface to present a help interface and information about the school district in the form of a list of frequently asked questions (FAQs).

In some embodiments, the user profile pane 304 includes interactive graphical user interface elements that prompt a student for information and then, when selected cause that information to be displayed (for example, in partial lists in the pane, in other windows, etc.). An update button 305, when selected, causes the graphical user interface, responsive to user inputs, to update user profile information (for example, a user picture 306, a user quote 307, user description 308, etc.). The first student activity panel 350 includes panes 315, 317, and 319. The second student activity panel 360 includes panes 330, 332, 334, and 336. The student dashboard also includes a search tab 370 that provides a mechanism to search for information entered through the student dashboard 300 and stored in a database, for example, the database 112. For example, the database may be searched for information associated with the student. In some embodiments, either of the first student activity panel 350 and the second student activity panel 360 may be used to capture the student's several goals. The category of student goals can include among other things academic goals, health goals, social goals, emotional goals, etc. These goals may be categorized based on duration (for example, long term goals versus short term goals). In some embodiments, the student can define explicitly the steps towards the completion for the goals.

In one example, the pane 315 is used by the student to provide information related to long term goals and purpose of the student (described in more detail below). The pane 315 includes a button 316 that can be used by the student to add various long term aspirational goals of the student. In one example, the student may use the pane 317 to provide information related to short term learning goals of the student. The pane 317 includes a button 318 that can be used by the student to add various short term learning goals of the student. In one example, the student may use the pane 319 to indicate progress associated with one or more of the goals that the student has selected. The pane 319 includes a button 320 that can be used to provide indications of progress associated with the one or more goals set by the student.

In one example, the student may use the pane 330 to display the student's interest. The pane 330 includes a button 331 that is used to add various interests of the student. Some examples of various interests of the student include, among other things, academic interest (for example, history, art, calculus, computer programming, etc.), extra-curricular interest (for example, the environment, politics, etc.), recreational interest (for example, soccer, football, etc.), and hobbies (for example, reading, gaming, fly-fishing, etc.). In one example, the student may use the pane 332 to display the student's area of strengths. The pane 332 includes a button 333 that is used to add various areas of the strength. Some examples of various strengths of the student include, among other things, art, science, math, public-speaking, etc. In one example, the student may use the pane 334 to display information related to good things or news that the student would like to share with a teacher. The pane 334 includes a button 335 that is used to add various good things that make the student happy. Some examples of various things that make the student happy include, among other things, music, painting, jazz, a hot bowl of ramen, etc. In one example, the student may use the pane 336 to display information related to the students work and reflections. The pane 336 includes a button 337 that is used to add new reflections by the student, teacher, mentor, or another individual having access to contents of the student dashboard. In some embodiments, the student can include new reflections by adding a text or image to a particular topic of student's work.

In one example, the student may use the mood tracker pane 340 to indicate the mood of the student using a mood tracker that includes several user-selectable mood indicator buttons 341-345 and a submit button 346. Mood indicator button 341 is associated with “an excited” state of the student. Mood indicator button 342 is associated with “a happy” state of the student. Mood indicator button 343 is associated with “an indifferent” state of the student. Mood indicator button 344 is associated with “a sad” state of the student. Mood indicator button 345 is associated with “an angry” state of the student. At any time, the student may choose any one of the user-selectable mood indicator buttons 341-345 and activate the submit button 346 to send a message to indicate the student's current state of mind to the teacher. In one example, the buttons 305, 316, 318, 320, 331, 333, 335, and 337 when activated open and display a window. The displayed window may be used by the user to enter information related to the panel within which the button resides.

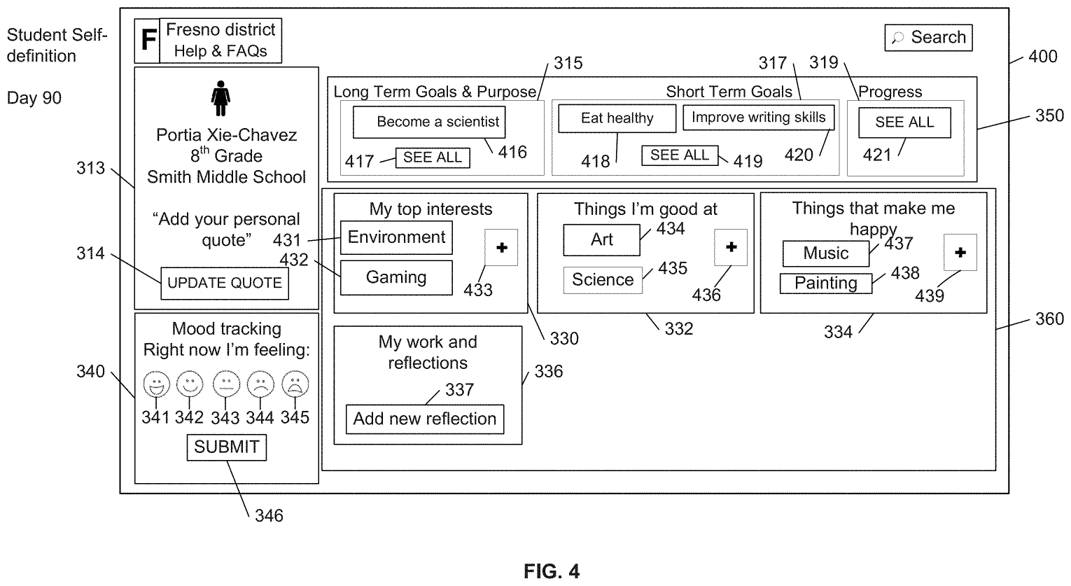

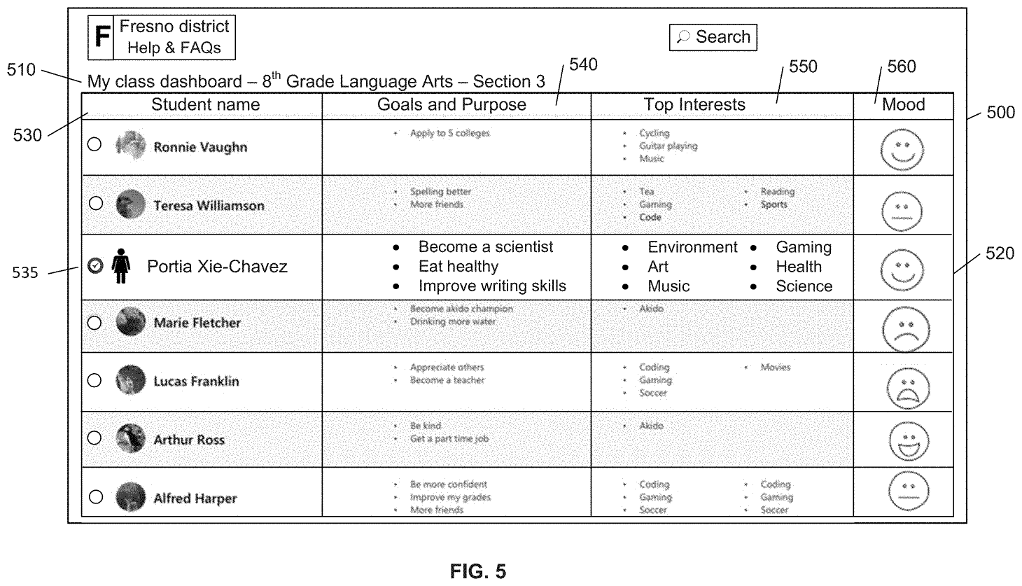

FIG. 4 is another example of a graphical user interface illustrating the student dashboard 400. The student dashboard 400 is used by the student to enter and display relevant information associated with the student to a teacher via a teacher dashboard shown in FIG. 5. In one example, the pane 315 includes a tag 416 labeled “Becoming a Scientist” to indicate the student's long term goals and purpose. Additionally, the pane 315 also includes a button 417 labeled “SEE ALL” that can be activated to display the entire list of long term goals and purpose associated with the student. In one example, the pane 317 includes a tag 418 labeled “Eat healthy” to indicate the student's short term goals and a tag 420 titled “Improve writing skills.” The pane 317 also includes a button 419 labeled “SEE ALL” that can be activated to display the entire list of short term goals of the student. In one example, the pane 319 includes a button 421 labeled “SEE ALL” that can be activated to display the progress of the student's long term and short term goals listed in panes 315 and 317, respectively.

In one example, the pane 330 titled “My top interests” includes a tag 431 labeled “Environment,” and a tag 432 labeled “Gaming” and the button 433 used to add additional interests of the student. In one example, the pane 332 labeled “Things I'm good at” includes a tag 434 labeled “Art,” and a tag 435 labeled “Science” and the button 436 used to add additional areas that the student is good at. In one example, the pane 334 labeled “Things that make me happy” includes a tag 437 labeled “Music,” a tag 438 labeled “Painting,” and the button 439 that can be used to add additional areas that makes the student happy.

FIG. 5 is another example of a graphical user interface illustrating a teacher dashboard 500. In the example shown in FIG. 5, the teacher dashboard includes a table 520 having columns 530, 540, 550, and 560. Column 530 lists a number of students (including the name and picture of the student) associated with the teacher. Column 540 lists the goals and purpose associated with each of the students listed in column 530. Column 550 lists the top interests associated with each of the students listed in column 530. Column 560 lists the mood associated with each of the students listed in column 530. In some embodiments, each of the rows associated with particular students may be selected using buttons located close to the picture and name of the student. For example, the button 535 associated with the student “Portia Xie-Chavez” is marked as selected in FIG. 5. This allows the teacher to select and view a subset of the total number of students as opposed to having the entire list of students shown. Additionally, the teacher may select a single student to review further details related to that particular student (in this case “Portio Xie-Chavez”).

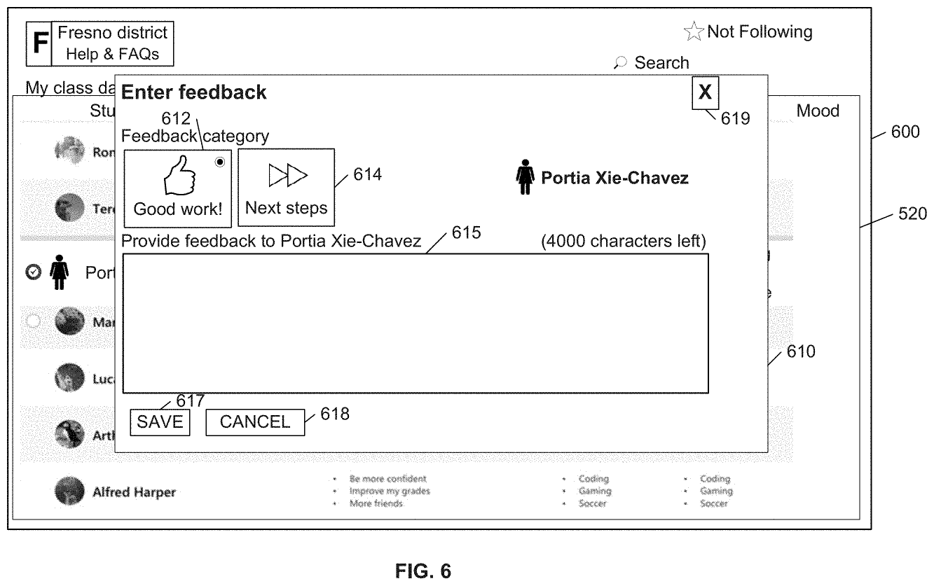

FIG. 6 is an example of a graphical user interface of the teacher dashboard 600 illustrating a feedback window 610 associated with a student. As shown in FIG. 6, the feedback window 610 includes a button 612 labeled “Good work!,” a button 614 labeled “Next steps,” a dialog box 615, a save button 617, a cancel button 618, and a close button 619. In some embodiments, the teacher can provide written feedback to the student (in this case student “Portia Xie-Chavez”). Once the written feedback has been completed, the teacher can save the contents by clicking on the save button 617. Additionally, the teacher may cancel the feedback process using the cancel button 618 and go back to the previous screen as shown in FIG. 5.

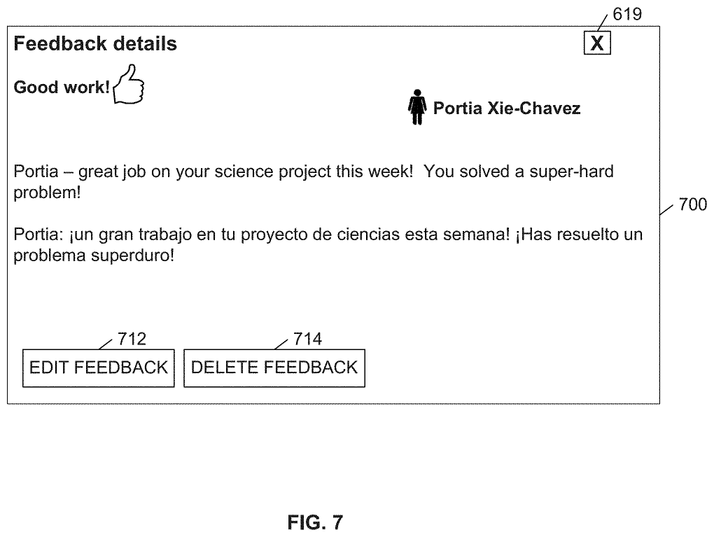

FIG. 7 is an example of a graphical user interface illustrating a completed feedback window associated with the student. As shown in FIG. 7, teacher feedback is included in the dialog box 700. The dialog box 700 includes an edit feedback button 712 that can be used to edit any feedback already entered in the dialog box. The dialog box 700 also includes a delete feedback button 714 that can be used to delete any feedback that has already been entered in the dialog box 700.

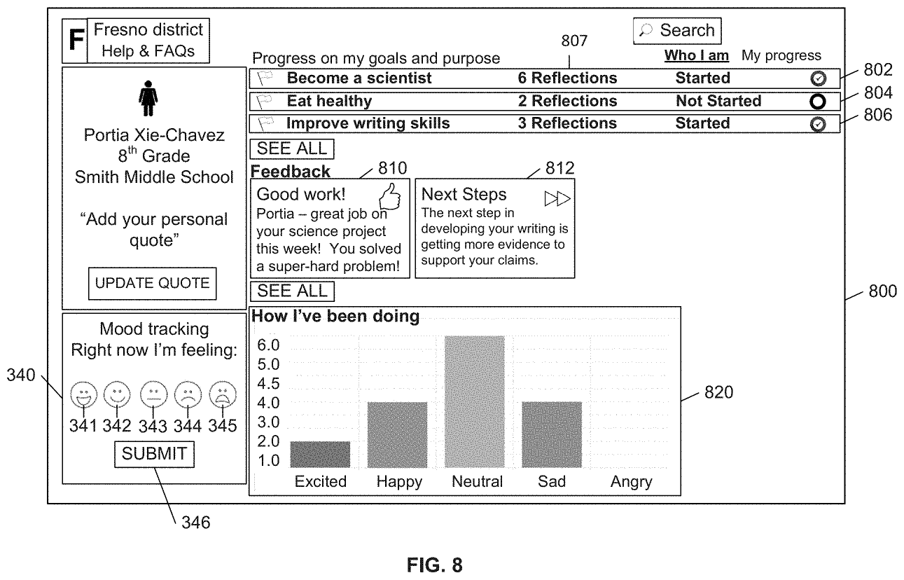

FIG. 8 is another example of a graphical user interface illustrating the student dashboard 800 including feedback pane 810 and instructions pane 812 received from for example, a teacher. The student dashboard 800 shown in FIG. 8 also includes a mood chart pane 820 showing a history of moods associated with the student. For example, the mood chart pane 820 shows that during a particular time period (for example, during a day in school) the student has been excited over two periods, happy over four period, neutral over six periods, sad over four periods, and not angry over any period. In addition, the student dashboard 800 includes progress tags 802, 804, and 806. The progress tag 802 is associated with the student's long term goal “Becoming a scientist” (shown as tag 416). The progress tag 804 is associated with the student's short term goal “Eat healthy” (shown as tag 418). The progress tag 806 is associated with another of the student's goals namely “Improve writing skills.” Each of the progress tag includes a count of one or more reflections 807 that indicates the number of reflections for each of the student's goals.

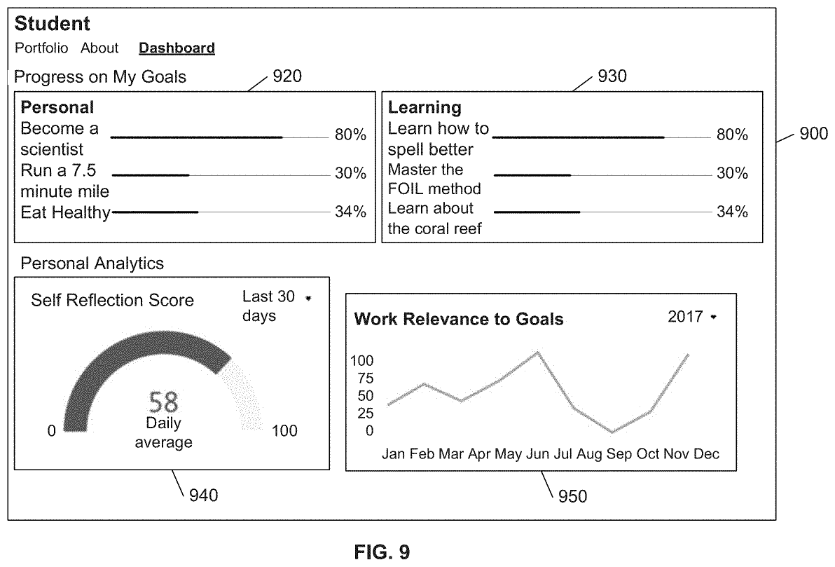

FIG. 9 is an example of a graphical user interface illustrating the student dashboard 900 showing personal analytics associated with the student. In some embodiments, the student dashboard 900 includes panes 920, 930, 940, and 950. In one example, the pane 920 shows personal progress towards the goals associated with the student. For example, the student has made 60% progress with regard to the goal of becoming a scientist. Similarly, the student has made 30% progress with regard to running a 7.5 minute mile. Also, the student has made 34% progress with regard to eating healthy. In some embodiments, student progress is calculated based on inputs received from the student over a period related to each of the goal items that is being monitored and displayed in pane 920. In one example, the pane 930 shows learning progress towards the academic goals associated with the student. For example, panel 930 shows the student having made 80% progress with regard to learning to program. The panel 930 also shows the student having made 40% progress with regard to mastering a trigonometry module. Additionally, the panel 930 also shows the student having made 22% progress with regard to learning about the coral reef.

As shown in FIG. 9, the personal analytics pane 940 provides a self-reflection score associated the student. The self-reflection score is determined by comparing student progress against their goals and across their emotional and self-awareness inputs. In this case, the self-reflection score is a daily average of 58 out of a maximum of 100 based on data collected over the last 30 days. In some embodiments, the self-reflection is calculated using a variety of parameters including personal progress, learning progress, etc. The panel 950 is graph showing the correlation of work related to the goals of the student over a period of a year. As shown in FIG. 9, the work performed by the student is highly correlated to the student's goals in the month of June and November, and is the least correlated during the month of September.

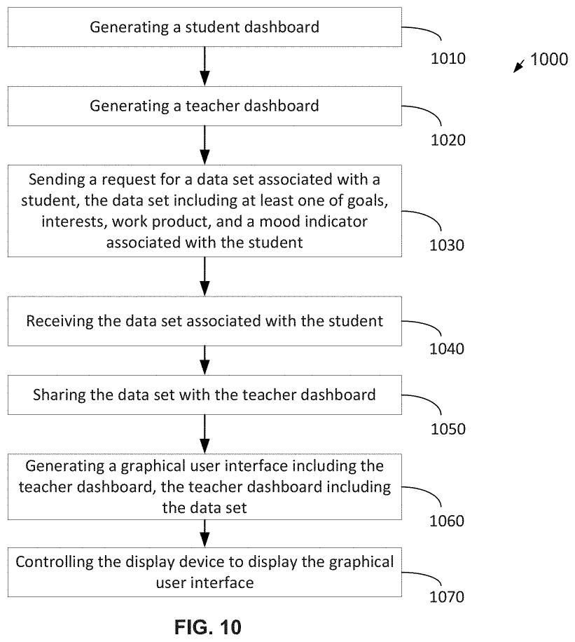

FIG. 10 is an example flow chart of a method 1000 for assisting student-centric learning, in accordance with some embodiments. At block 1010, the electronic processor 210 generates a student dashboard 300. In some embodiments, various parameters associated the student are populated by entering data using a template as shown in the student dashboard 300 (FIG. 3). Embodiments described herein allow students to enter their goals (in some examples, using free text format) and have their mentors or teachers view these goals and add simple tags that might allow a “topical characterization” of these goals. In some embodiments, a topic model is developed for each of the goals and a machine learning model is used to learn the association between goals and tags. In some instances, the tags eventually feed a recommender system or are used to train a “goal setting bot.” The tags also facilitate a social mapping between similarly interested students, which further allows for “group or team mentoring” or “peer mentoring” around subjects students want to learn.

At block 1020, the electronic processor 210 generates a teacher dashboard (for example, the teacher dashboard 500). In some embodiments, a teacher can enter a preference for displaying profiles of the students in the teacher's class by using a graphical user interface elements associated with the teacher dashboard. In some embodiments, the teacher can provide feedback (for example, using the dialog box 700) using graphical user interface elements of the teacher dashboard 500. In one example, the feedback is displayed in the student dashboard (for example, feedback 810 displayed in the student dashboard 800).

At block 1030, the electronic processor 210 sends a request for a data set associated with a student. In some embodiment, the data set includes one or more goals (for example, goals identified by the student denoted by the tags 416, 418, and 420 in FIG. 4). In some embodiments, the data set includes student interests (for example, the interests identified by the student denoted by the tags 431, and 432 in FIG. 4). In some embodiments, the data set includes work product of the student (for example, the work product identified by the student using the pane 336). In some embodiments, the data set includes a mood indicator associated with the student that is provided by the student by activating one of the moods available in pane 340 (for example, the student, Portia Xie-Chavez activates the mood indicator 342 to denote that she is in a “Happy” state). At block 1040, the electronic processor 210 receives the data set (as provided in block 1030) associated with the student and shares the data set with the teacher dashboard 500 (at block 1050). Data from the data set in populated in the teacher dashboard.

At block 1060, the electronic processor 210 generates a graphical user interface including the teacher dashboard (for example, the teacher dashboard 500). At block 1070, the electronic processor 210 controls the display device 123 to display the graphical user interface using the display device 123. In some embodiments, the electronic processor 210 is configured to control the display device 123 to display a mood chart associated with a student. In one example, the mood chart provides a history of mood indicators provided by the student over a period of time. In some embodiments, an aggregate of the moods associated with a student is determined and displayed on the displayed on the display device 123 using the electronic processor 210. In some embodiments, the electronic processor 210 is configured to control the display device 123 to display a class mood. In one example, the class mood includes an aggregate of the mood indicators associated with all the students in a particular teacher's class. In some embodiments, the electronic processor 210 is configured to control the display device 123 to display a progress chart associated with a student. In one example, the progress chart provides a visual indication of the progress made by the student towards a goal selected from the group consisting of an academic goal, a health goal, a social goal, and an emotional goal.

Various features and advantages of some embodiments are set forth in the following claims.

What is claimed is:

1. A system for assisting student-centric learning, the system comprising:
a display device;
an electronic processor communicatively connected to the display device and configured to
generate a student dashboard;
generate a teacher dashboard;
send a request for a data set associated with a student, the data set including an item selected from the group consisting of a goal, an interest, a work product, and a mood indicator associated with the student;
receive the data set associated with the student,
share the data set with the teacher dashboard;
generate a graphical user interface including the teacher dashboard, the teacher dashboard including data from the data set; and
control the display device to display the graphical user interface.

2. The system of claim 1, wherein the electronic processor is configured to send, via the teacher dashboard, feedback data from the teacher dashboard to the student dashboard.

3. The system of claim 2, wherein the student dashboard further comprises:
a feedback pane, the feedback pane configured to display feedback from teacher.

4. The system of claim 1, wherein the interests associated with the student includes an item selected from the group consisting of academic interest, extra-curricular interest, recreational interest, and hobbies.

5. The system of claim 1, wherein the teacher dashboard further comprises:
a mood chart having a history of mood indicators associated with the student.

6. The system of claim 1, wherein the teacher dashboard further comprises:
a class mood indicator, the class mood indicator determined based on an aggregate of mood indicators associated with a plurality of students in a class.

7. The system of claim 1, wherein the student dashboard further comprises:
a progress chart associated with the student, wherein the progress chart provides a visual indication of progress made by the student towards a goal.

8. The system of claim 7, wherein the goal associated with the student includes an item selected from the group consisting of an academic goal, a health goal, a social goal, and an emotional goal.

9. The system of claim 1, wherein the student dashboard further comprises:
a mood tracker associated with the student.

10. The system of claim 9, wherein the mood tracker further comprises a plurality of user-selectable buttons to indicate a mood selected from the group consisting of excited, happy, indifferent, sad, and angry.

11. A method for assisting student-centric learning the method comprising:
generating a student dashboard;
generating a teacher dashboard;
sending a request for a data set associated with a student, the data set including an item selected from the group consisting of a goal, an interest, a work product, and a mood indicator associated with the student;
receiving the data set associated with the student,
sharing the data set with the teacher dashboard;
generating a graphical user interface including the teacher dashboard, the teacher dashboard including data from the data set; and
displaying the graphical user interface using a display device.

12. The method of claim 11, further comprising:
sending, with the teacher dashboard, feedback data from the teacher dashboard to the student dashboard.

13. The method of claim 11, wherein the interests associated with the student includes an item selected from the group consisting of academic interest, extra-curricular interest, recreational interest, and hobbies.

14. The method of claim 11, wherein generating the teacher dashboard includes generating a mood chart having a history of mood indicators associated with the student.

15. The method of claim 11, wherein generating the teacher dashboard includes displaying a class mood, wherein the class mood includes an aggregate of mood indicators associated with a plurality of students in a class.

16. The method of claim 11, wherein generating the graphical user interface includes displaying a progress chart associated with the student.

17. The method of claim 16, wherein displaying the progress chart associated with the student includes displaying a visual indication of progress made by the student towards a goal selected from the group consisting of an academic goal, a health goal, a social goal, and an emotional goal.

18. The method of claim 11, further comprising:
receiving, with the student dashboard, a selection of a mood indicator associated with the student, wherein the mood indicator associated with the student indicates a mood selected from the group consisting of excited, happy, indifferent, sad, and angry.

19. A non-transitory computer-readable medium containing instructions that when executed by one or more electronic processors cause the one or more electronic processors to:
generate a student dashboard;
generate a teacher dashboard;
send a request for a data set associated with a student, the data set including an item selected from the group consisting of a goal, an interest, a work product, and a mood indicator associated with the student;
receive the data set associated with the student,
share the data set with the teacher dashboard;
generate a graphical user interface including the teacher dashboard, the teacher dashboard including data from the data set; and
display the graphical user interface using a display device.

20. The non-transitory computer-readable medium of claim 19, further containing instructions that when executed by the one or more electronic processors cause the one or more electronic processors to:
generate the graphical user interface to include the teacher dashboard displaying a class mood, wherein the class mood includes an aggregate of mood indicators associated with a plurality of students in the class.
